(19) United States
(12) Patent Application Publication
(10) Pub. No.: US 2006/0007806 A1
(43) Pub. Date: Jan. 12, 2006

(54) APPARATUS AND METHOD FOR GENERATING A TRACKING ERROR SIGNAL IN AN OPTICAL DISC DRIVE

(76) Inventors: Wei-Hung He, Taipei Hsien (TW); Kuang-Yu Yen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/160,692

(22) Filed: Jul. 6, 2005

(30) Foreign Application Priority Data
Jul. 8, 2004 (TW) 093120463

(51) Int. Cl. G11B 7/00

(52) U.S. Cl. 369/44.34; 369/44.28; 369/44.41

(57) ABSTRACT

The present invention discloses an apparatus and method for generating a tracking error signal in an optical disc drive. The apparatus contains an optical detection module, an ADC module, a phase detection module, and a filter module. The optical detection module generates a first analog signal and a second analog signal. The ADC module samples the first and second signals in a first sampling time to generate a first digital value and a second digital value, and samples the first and second signals in a second sampling time to generate a third digital value and a fourth digital value. The phase detection module generates a digital phase difference value according to the first, the second, the third, and the fourth digital values. The filter module generates the tracking error signal according to the digital phase difference value.

### BACKGROUND OF THE INVENTION

1. Field of the Invention

The present invention relates to an optical disc drive, and more particularly, to an apparatus for generating a tracking error signal in the optical disc drive.

2. Description of the Prior Art

Optical discs are storage systems used nowadays. Data is recorded according to the pits in the optical disc tracks. A servo control system of an optical disc drive reads the data by focusing a laser light outputted from a laser light diode on a correct position of the track and detecting the reflection light beam of the laser light.

An optical sensor on a pick-up head (PUH) of the optical disc drive detects signals A, B, C, D reflected from different positions of the track and generates a tracking error signal TE. The servo control system determines whether the focus point of the laser light outputted by the laser light diode diverges from the track of the optical disc according to the changes in the tracking error signal TE.

Please refer to FIG. 1. FIG. 1 is a schematic diagram of a prior art for generating a tracking error signal TE in an optical disc drive. The signals A and C detected by the optical sensor of the PUH are processed by the adder 112, the equalizer 122, and the slicer 132 and then the digitalized A and C are inputted to the phase detector 140. The signals B and D detected by the optical sensor are processed by the adder 114, the equalizer 124, and the slicer 134 and then the digitalized B and D are inputted to the phase detector 140. The phase detector 140 detects the phase difference between the digitalized signal A+C and the digitalized signal B+D, and the output signal from the phase detector 140 is then processed by the low pass filters (LPF) 152 and 154 and the differential amplifier 160 for generating the tracking error signal TE. The larger the phase difference between the signals A+C and B+D, the wider the signal pulse width outputted from the phase detector 140 is. Since the prior art determines the phase difference according to a pulse width, a high sampling rate to convert the analog signal into the digital signal is required for accurate tracking error signal TE and the backend circuits must operate in a higher frequency.

### SUMMARY OF THE INVENTION

One objective of the claimed invention is to provide an apparatus and a method thereof, for generating a tracking error signal with high resolution and lower sampling rate.

The present invention discloses an apparatus for generating a tracking error signal in an optical disc drive. The apparatus comprises an optical detection module for generating a first analog signal and a second analog signal according to at least one reflection light beam of a laser light emitted to an optical disc; an ADC module coupled to the optical detection module for sampling the first and second analog signals in a first sampling time to generate a first digital value and a second digital value respectively, and sampling the first and second analog signals in a second sampling time to generate a third digital value and a fourth digital value respectively; a phase detection module coupled to the ADC module for calculating a digital phase difference value according to the first, second, third and fourth digital values; and a filter module coupled to the phase detection module for generating the tracking error signal according to the digital phase difference.

The present invention further discloses a method for generating a tracking error signal in an optical disc drive. The method comprises generating a first analog signal and a second analog signal according to at least one reflection light beam of a laser light emitted to an optical disc; converting the first and second analog signals into a first digital value and a second digital value respectively in a first sampling time; converting the first and second analog signals into a third digital value and a fourth digital value respectively in a second sampling time; calculating a digital phase difference value according to the first, second, third and fourth digital values; and generating the tracking error signal according to the digital phase difference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a prior art apparatus for generating a tracking error signal in an optical disc drive.

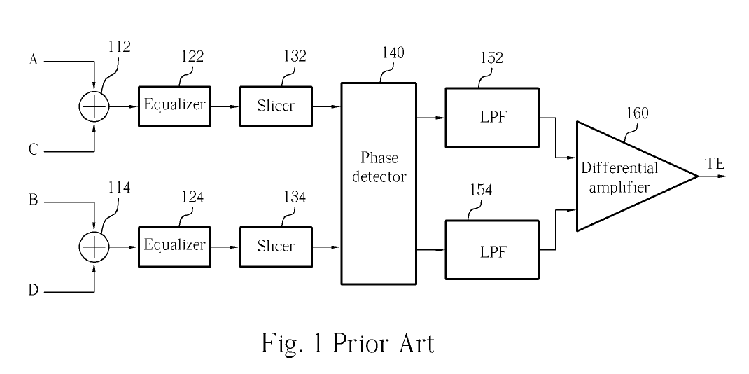

FIG. 2 is an apparatus according to an embodiment of the present invention.

FIG. 3 is an example of a waveform diagram of input and output signals of the ADC module shown in FIG. 2.

FIG. 4 is an apparatus in the phase detection module of FIG. 2 for generating a DC offset compensating signal and a gain control signal according to an embodiment of the present invention.

FIG. 5 is a flowchart describing a method according to the present invention.

### DETAILED DESCRIPTION

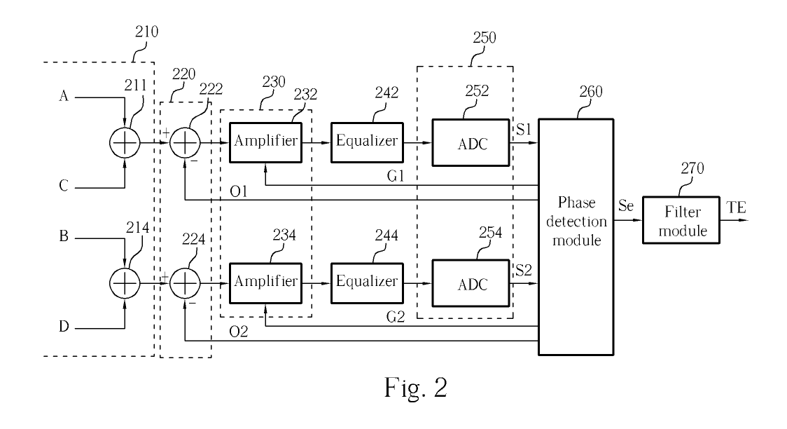

Please refer to FIG. 2. FIG. 2 is a schematic diagram of an apparatus for generating a tracking error signal in an optical disc drive according to an embodiment of the present invention. The present invention comprises: an optical detection module 210, a DC level adjusting module 220, a gain adjusting module 230, an ADC module 250, a phase detection module 260 and a filter module 270. The optical detection module 210 generates a first analog signal A+C and a second analog signal B+D according to signals A, B, C, and D generated by detecting the reflection light beam of a laser light emitted to an optical disc. The DC level adjusting module 220 utilizes the first and second DC offset compensating signals O1 and O2 to adjust DC levels of the first signal A+C and the second analog signal B+D respectively. The gain adjusting module 230 adjusts the first analog signal A+C and the second analog signal B+D according to the first gain control signal G1 and the second gain control signal G2 respectively. The ADC module 250 comprises two multi-bit ADCs 252 and 254 for generating the first digital signal S1 and the second digital signal S2 according to the first analog signal A+C and the second analog signal B+D respectively, wherein each sample point of the first and second digital signals S1 and S2 comprises a plurality of bits. The phase detection module 260 generates a digital phase difference signal Se according to the first and second digital signals S1 and S2. The filter module 270 is utilized to filter the digital phase difference signal Se to generate the needed tracking error signal TE, and the filter module 270 can be a low pass filter.

The phase detection module 260 of the present embodiment detects the positive and negative sign of the first and second digital signals S1 and S2 to determine whether zero crossing occurs between which sample points and tp determine the degree of the phase difference between the signals S1 and S2. Since the first digital signal S1 corresponds to the first analog signal A+C and the second digital signal S2 corresponds to the second analog signal B+D, a lead/lag situation between the first analog signal A+C and the second analog signal B+D can be determined according to the phase difference between the signals S1 and S2. For example, assume the first and second digital signals S1 and S2 of a first digital value S1(n−1) and a second digital value S2(n−1) respectively in a first sampling time, and of a third digital value S1(n) and a fourth digital value S2(n) in a second sampling time. The phase detection module 260 determines whether a zero crossing exists between the first and second sampling times of the first and second digital signals S1 and S2 by comparing a predetermined value 0 with the first, second, third, and fourth digital values S1(n−1), S2(n−1), S1(n), S2(n). If the first digital value S1(n−1) is less than zero and the third digital value S1(n) is larger than zero, a zero crossing occurs from negative to positive between the first and second sampling times of the first digital signal S1. If the second digital value S2(n−1) is less than zero and the fourth digital value S2(n) is larger than zero, a zero crossing occurs from negative to positive between the first and second sampling times of the second digital signal S2. In the above mentioned situations, the phase detection module 260 utilizes the value of the sum of the first and third digital values S1(n−1), S1(n) minus the sum of the second and fourth digital values S2(n−1), S2(n) as a phase difference value Se(n). If the phase difference value Se(n) is positive, the first analog signal A+C precedes the second analog signal B+D. If the phase difference value Se(n) is negative, the second analog signal B+D precedes the first analog signal A+C. Whether the first analog signal A+C precedes the second analog signal B+D, the larger an absolute value of the phase difference value Se(n), the larger the phase difference between the first analog signal A+C and the second analog signal B+D is, and the smaller the absolute value of the phase difference value Se(n), the smaller the phase difference between the first analog signal A+C and the second analog signal B+D is.

Similarly, if the first digital value S1(n−1) is larger than zero and the third digital value S1(n) is smaller than zero, a zero crossing occurs from positive to negative between the first and second sampling times of the first digital signal S1. If the second digital value S2(n−1) is larger than zero and the fourth digital value S2(n) is smaller than zero, a zero crossing occurs from positive to negative between the first and second sampling times of the second digital signal S2. In the above mentioned two situations, the phase detection module 260 utilizes the value of the sum of the second and fourth digital values S2(n−1) and S2(n) minus the sum of the first and third digital values S1(n−1) and S1(n) as a phase difference value Se(n). If the phase difference value Se(n) is positive, it the first analog signal A+C precedes the second analog signal B+D, and if the phase difference value Se(n) is negative, the second analog signal B+D precedes the first analog signal A+C. Whether the first analog signal A+C precedes the second analog signal B+D, the greater an absolute value of the phase difference value Se(n), the greater the phase difference between the first analog signal A+C and the second analog signal B+D is, and the smaller the absolute value of the phase difference value Se(n), the smaller the phase difference between the first analog signal A+C and the second analog signal B+D is.

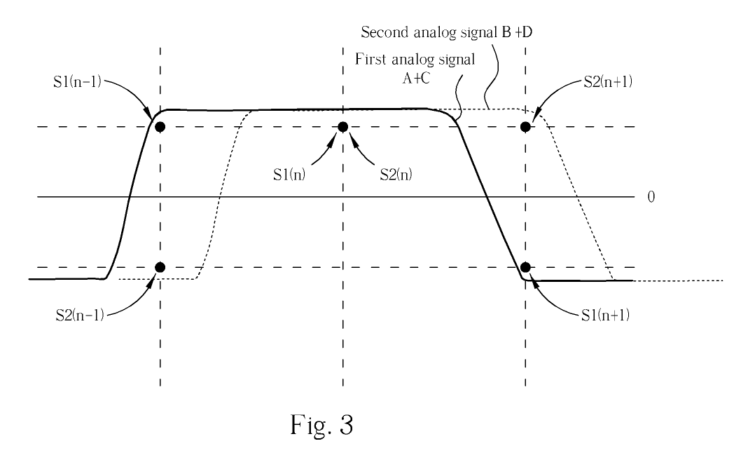

FIG. 3 is an example of a waveform diagram of input and output signals of the ADC module shown in FIG. 2. In this example, the first analog signal A+C precedes the second analog signal B+D. Since S2(n−1)<0 and S2(n)>0, the phase detection module 260 determines that a zero crossing occurs between the sample points (n−1) and n of the signal S2, and hence the phase detection module 260 utilizes [S1(n−1)+S1(n)−S2(n−1)−S2(n)] as the value of Se(n). The Se(n) is positive at this moment, meaning that the phase of the first analog signal A+C precedes the phase of the second analog signal B+D. Similarly, if S1(n)>0 and S1 (n+1)<0, the phase detection module 260 determines that a zero crossing occurs from positive to negative between the sample points n and (n+1) of the signal S1, and hence the phase detection module 260 utilizes [S2(n)+S2(n+1)−S1(n)−S1(n+1)] as the value of Se(n+1). In this case, Se(n+1) is positive at this moment, meaning that the phase of the first analog signal A+C precedes the phase of the second analog signal B+D. In other situations, the value of Se (n) are set to zero.

Since the ADC module 250 is a multi-bit ADC module, the larger the phase difference between the two signals S1 and S2 of the above two situations, the larger the digital phase difference signal Se is, meaning that the pulse height of the signal is higher, and hence the phase difference between the signals S1 and S2 is contained in the digital phase difference signal Se outputted from the phase detection module 260. In this embodiment, the tracking error signal TE can be generated by determining and filtering with the LPF 270 the digital phase difference signal Se comprising a plurality of digital phase differences Se (n) at a plurality of sampling times.

The multi-level digital signals S1 and S2 are utilized for calculating the related level difference between the sampled A+C signal and B+D signals in order to obtain the corresponding phase difference. Therefore, the sampling rate is efficiently lowered. For example, the sampling rate can be lowered to 1/2T, wherein T is a period corresponding to a channel bit of the optical disc. The signal resolution required for the tracking error signal is also achieved.

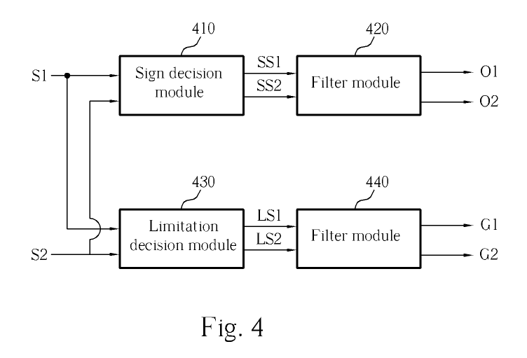

Generally, the analog signals A+C and B+D generated by the optical detection module 210 includes DC offset and need to be amplified properly before being inputted to the ADC module 250. Accordingly, the embodiment comprises the DC level adjusting module 220 for adjusting the DC offsets of the analog signals A+C and B+D, and the gain adjusting module 230 for amplifying the analog signals A+C and B+D. In this embodiment, the phase detection module 260 further comprises the apparatus shown in FIG. 4, the sign decision module 410 and the filter module 420 for generating the first and second DC offset compensating signals O1 and O2, and the limitation decision module 430 and the filter module 440 for generating the first and second gain control signals G1 and G2.

In this embodiment, the sign decision module 410 performs a sign operation according to the signals S1 and S2 respectively for generating a first sign signal SS1 and a second sign signal SS2. The filter module filters the signals SS1 and SS2 respectively for generating the DC offset compensating signals O1 and O2. When the corresponding value of the signal S1 is larger than zero, the first sign signal SS1 generated by the sign decision module 410 equals positive one. When the corresponding value of the signal S1 is smaller than zero, the first sign signal SS1 generated by the sign decision module 410 equals negative one. Obviously, if the DC offset of the analog signal A+C is positive, the first sign signal SS1 comprises more positive values (+1) than negative values (−1). Accordingly, the filter module offers a positive DC offset compensating signal O1 to the adder 220 for compensating the positive DC offset of the analog signal A+C. On the contrary, if the DC offset is negative, the signal SS1 comprises more negative values (−1) than positive values (−1). Therefore, the filter module offers a negative DC offset compensating signal O1 to the adder 220 for compensating the negative DC offset of the analog signal A+C.

In this embodiment, the limitation decision module 430 determines whether the signals S1 and S2 reach an upper limitation value or a lower limitation value to generate a first decision signal LS1 and a second decision signal LS2 respectively. The filter module filters the signals LS1 and LS2 to generate the gain control signals G1 and G2 respectively. Suppose the ADC module 250 is a three-bit ADC module. When the corresponding value of the signal S1 reaches the upper limitation value 111 or the lower limitation value 000, the first decision signal LS1 generated by the limitation decision module 430 equals a first output value α. When the corresponding value of the signal S1 does not reach the upper limitation value 111 or the lower limitation value 000, the first decision signal LS1 generated by the limitation decision module 430 equals a first output value β. If the gain of the amplifier 230 is too large, the larger part of the absolute value of the amplified analog signal A+C will exceed the range capable of conversion of the ADC 252. Accordingly, more upper limitation values 111 or lower limitation values 000 are included in the signal S1, and the first decision signal LS1 has more α values, meaning that the system can lower the gain of the amplifier 230. On the contrary, if the gain of the amplifier 230 is too small, larger parts of the amplified analog signal A+C lies in the convertible range of the ADC 252. Accordingly, less upper limitation values 111 or lower limitation values 000 are included in the signal S1. In this situation, the first decision signal LS1 has more β values, meaning that the system can increase the gain of the amplifier 230. The values α and β are designable.

Please note that the signals A and B can also be the first and second analog signals respectively or the signals C and D can be the first and second analog signals respectively.

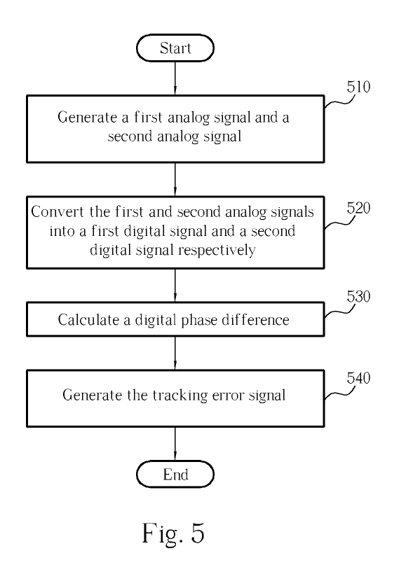

Please refer to FIG. 5. FIG. 5 is a flowchart for generating a tracking error signal in an optical disc drive according to the present invention. Each step is described as follows.

Step 510: Generate a first analog signal and a second analog signal according to a reflection light beam of a laser light emitted to an optical disc. In the embodiment, the first analog signal corresponds to the signals A and C generated by the optical sensor, and the second analog signal corresponds to the signals B and D generated by the optical sensor.

Step 520: Convert the first and second analog signals into a first digital signal S1 and a second digital signal S2 respectively. The first and second digital signals S1 and S2 are equal to a first digital value S1(n−1) and a second digital value S2(n−1) respectively in a first sampling time, and are equal to a third digital value S1(n) and a fourth digital value S2(n) respectively in a second sampling time.

Step 530: Calculate a digital phase difference Se(n) according to the first, second, third, and fourth digital values S1(n−1), S2(n−1), S1(n), S2(n) respectively. A digital phase difference signal Se includes a plurality of digital phase differences Se(n) generated at different sampling times. The embodiment utilizes the signals S1(n−1)+S1(n)−S2(n−1)−S2(n) as the digital phase differences Se(n) if the signal S1(n−1) is less than zero and the signal S1(n) is larger than zero or if the signal S2(n−1) is less than zero and the signal S2(n) is larger than zero. The embodiment utilizes the signals S2(n−1)+S2(n)−S1(n−1)−S1(n) as the digital phase differences Se(n) if the signal S1(n−1) is larger than zero and the signal S1(n) is less than zero or if the signal S2(n−1) is larger than zero and the signal S2(n) is less than zero. In other situations, the digital phase differences Se(n) equals zero.

Step 540: Generate the tracking error signal TE according to the digital phase difference signal Se.

The DC levels of the first and second analog signals can be adjusted dynamically in the above-mentioned steps. The present invention further comprises the following steps:

Step 610: Perform a sign operation on the first and second digital signals S1 and S2 and generate a first sign signal SS1 and a second sign signal SS2.

Step 620: Filter the first and second sign signals SS1 and SS2 to generate a first DC offset compensating signal O1 and a second DC offset compensating signal O2 respectively.

Step 630: Adjust the DC levels of the first and second analog signals according to the first and second DC offset compensating signals O1 and O2.

Similarly, the gains of the first and second analog signals can be adjusted dynamically in the above-mentioned steps. The present invention further comprises the following steps:

Step 710: Generate a first decision signal LS1 and a second decision signal LS2 according to the first and second digital signals S1 and S2. When a digital signal reaches an upper limitation value or a lower limitation value, the decision signal corresponding to the digital signal has a first output value α. When the digital signal does not reach the upper limitation value or the lower limitation value, the decision signal corresponding to the digital signal has a second output value β.

Step 720: Filter the first and second decision signals LS1 and LS2 to generate a first gain control signal G1 and a second gain control signal G2 respectively.

Step 730: Amplify the first and second analog signals according to the first and second gain control signals G1 and G2.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for generating a tracking error signal in an optical disc drive, the apparatus comprising:
an optical detection module for generating a first analog signal and a second analog signal according to at least one reflection signal; an ADC (Analog-to-digital) module coupled to the optical detection module for respectively sampling the first and second analog signals in a first sampling time to generate a first digital value and a second digital value, and respectively sampling the first and second analog signals in a second sampling time to generate a third digital value and a fourth digital value;
a phase detection module coupled to the ADC module for calculating a digital phase difference value according to the first, second, third and fourth digital values, wherein the digital phase difference value corresponds to an analog phase difference of the first and second analog signals; and
a first filter module coupled to the phase detection module for generating the tracking error signal according to the digital phase difference.

2. The apparatus of claim 1, wherein the phase difference value is equal to a sum of the first and third digital values minus a sum of the second and fourth digital values.

3. The apparatus of claim 2, wherein the first digital value is smaller than a predetermined value and the third digital value is larger than the predetermined value.

4. The apparatus of claim 2, wherein the second digital value is smaller than the predetermined value and the fourth digital value is larger than the predetermined value.

5. The apparatus of claim 2, wherein the phase difference value is larger than zero if a phase of the first analog signal precedes a phase of the second analog signal.

6. The apparatus of claim 2, wherein the phase difference value is smaller than zero if the phase of the second analog signal precedes the phase of the first analog signal.

7. The apparatus of claim 1, wherein the ADC module comprises a multi-bit ADC.

8. The apparatus of claim 7, wherein the first, second, third, and fourth digital values all comprise a multi-bit digital value.

9. The apparatus of claim 1, further comprising:
a sign decision module coupled to the ADC module for generating a first sign signal corresponding to the first and third digital values and generating a second sign signal corresponding to the second and fourth digital values; and a second filter module coupled to the sign decision module for generating a first DC offset compensating signal according to the first sign signal and a second DC offset compensating signal according to the second sign signal.

10. The apparatus of claim 9, further comprising a DC level adjusting module coupled to the second filter module for utilizing the first and second DC offset compensating signals to adjust DC levels of the first and second analog signals respectively.

11. The apparatus of claim 1, further comprising:
a limitation decision module coupled to the ADC module for outputting a first decision signal according to the first and third digital values, and outputting a second decision signal according to the second and fourth digital values;
a third filter module coupled to the limitation decision module for generating a first gain control signal and a second gain control signal according to the first and second decision signals respectively; and
a gain adjusting module coupled to the third filter module for adjusting the first and second analog signals according to the first and second gain control signals respectively.

12. The apparatus of claim 11, wherein the limitation decision module generates the decision signal of a first value if the digital value is larger than an upper limitation value and smaller than a lower limitation value, and generates the decision signal of a second value if the digital value is between the upper and lower limitation values.

13. A method for generating a tracking error signal in an optical disc drive, the method comprising the following steps:
generating a first analog signal and a second analog signal according to at least one reflection signal; converting the first and second analog signals into a first digital value and a second digital value respectively in a first sampling time;
converting the first and second analog signals into a third digital value and a fourth digital value respectively in a second sampling time;
calculating a digital phase difference value according to the first, second, third and fourth digital values, wherein the digital phase difference value corresponds to an analog phase difference of the first and second analog signals; and
generating a tracking error signal according to the digital phase difference.

14. The method of claim 13, wherein the phase difference value is equal to a sum of the first and third digital values minus a sum of the second and fourth digital values.

15. The method of claim 14, wherein the first digital value is smaller than a predetermined value and the third digital value is larger than the predetermined value.

16. The method of claim 14, wherein the second digital value is smaller than the predetermined value and the fourth digital value is larger than the predetermined value.

17. The method of claim 13, wherein the phase difference value is equal to a sum of the second and fourth digital values minus a sum of the first and third digital values if the first digital value is larger than a predetermined value and the third digital value is smaller than the predetermined value, and if the second digital value is larger than the predetermined value and the fourth digital value is smaller than the predetermined value.

18. The method of claim 13, further comprising:
generating a first sign signal according to the first and third digital values performing and generating a second sign signal according to the second and fourth digital values; filtering the first and second sign signals to generate a first DC offset compensating signal and a second DC offset compensating signal respectively; and
adjusting DC levels of the first and second analog signals respectively according to the first and second DC offset compensating signals.

19. The method of claim 13, further comprising:
generating a first decision signal according to the first and third digital values, and generating a second decision signal according to the second and fourth digital values;
generating a first gain control signal and a second gain control signal according to the first and second decision signals respectively; and
adjusting the first and second analog signals according to the first and second gain control signals respectively.

20. The method of claim 19, wherein the decision signal is a first value if the digital value is larger than an upper limitation value and smaller than a lower limitation value, and the decision signal is a second output value if the digital value is between the upper and lower limitation values.

21. An apparatus for generating a tracking error signal in an optical disc drive, the apparatus comprising:
an optical detection module for generating a first analog signal and a second analog signal according to at least one reflection signal;
an multi-bit ADC (Analog-to-digital) module coupled to the optical detection module for generating a first digital signal and a second digital signal;
a phase detection module coupled to the ADC module for calculating a digital phase difference value according to the first digital signal and the second digital signal in a first sampling time and a second sampling time; and
a first filter module coupled to the phase detection module for generating the tracking error signal according to the digital phase difference.

22. The apparatus of claim 21, wherein the first and second digital signals are multi-level signals.

23. A method for generating a tracking error signal in an optical disc drive, the method comprising the following steps:
generating a first analog signal and a second analog signal according to at least one reflection signal;
converting the first and second analog signals into a first digital signal and a second digital signal, wherein the first and second digital signals are multi-level signals;
sampling respectively the first and second digital signals for generating a first digital value and a second digital value in a first sampling time;
sampling respectively the first and second analog signals for generating a third digital value and a fourth digital value in a second sampling time;
calculating a digital phase difference value according to the first, second, third and fourth digital values, wherein the digital phase difference value corresponds to an analog phase difference of the first and second analog signals; and
generating a tracking error signal according to the digital phase difference.
